(19) United States
(12) Patent Application Publication
(10) Pub. No.: US 2024/0178569 A1
(43) Pub. Date: May 30, 2024

(54) MOBILE DEVICE SUPPORTING WIDEBAND OPERATION

(71) Applicant: Acer Incorporated, New Taipei City (TW)

(72) Inventors: Kun-Sheng CHANG, New Taipei City (TW); Ching-Chi LIN, New Taipei City (TW)

(21) Appl. No.: 18/166,090

(22) Filed: Feb. 8, 2023

(30) Foreign Application Priority Data
Nov. 28, 2022 (TW) 111145404

(51) Int. Cl. H01Q 13/10; H01Q 1/22

(52) U.S. Cl. CPC H01Q 13/10; H01Q 1/2291

(57) ABSTRACT

A mobile device supporting wideband operations includes a first metal mechanism element, a dielectric substrate, a feeding radiation element, a ground element, a second metal mechanism element, and a nonconductive antenna window. The first metal mechanism element includes a main portion and a sidewall portion. The sidewall portion has a slot. The dielectric substrate is adjacent to the sidewall portion of the first metal mechanism element. The feeding radiation element extends across the slot of the first metal mechanism element. An antenna structure is formed by the slot of the first metal mechanism element, the dielectric substrate, the feeding radiation element, and the ground element. The second metal mechanism element is disposed opposite from the main portion of the first metal mechanism element. The nonconductive antenna window is connected between the sidewall portion of the first metal mechanism element and the second metal mechanism element.

### CROSS REFERENCE TO RELATED APPLICATIONS

This application claims priority of Taiwan Patent Application No. 111145404 filed on Nov. 28, 2022, the entirety of which is incorporated by reference herein.

### BACKGROUND OF THE INVENTION

### Field of the Invention

The disclosure generally relates to a mobile device, and more particularly, to a mobile device supporting wideband operations.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHZ, 1900 MHZ, 2100 MHz, 2300 MHz, and 2500 MHz. Some devices cover a small wireless communication area; these include mobile phones using Wi-Fi systems and using frequency bands of 2.4 GHz, 5.2 GHz, and 5.8 GHz.

Antennas are indispensable elements for wireless communication. If an antenna for signal reception and transmission has insufficient operational bandwidth, it may degrade the communication quality of the relative mobile device. Accordingly, it has become a critical challenge for designers to design a small-size, wideband antenna structure.

### BRIEF SUMMARY OF THE INVENTION

In an exemplary embodiment, the invention is directed to a mobile device supporting wideband operations. The mobile device includes a first metal mechanism element, a dielectric substrate, a feeding radiation element, a ground element, a second metal mechanism element, and a nonconductive antenna window. The first metal mechanism element includes a main portion and a sidewall portion. The sidewall portion has a slot. The dielectric substrate is adjacent to the sidewall portion of the first metal mechanism element. The feeding radiation element has a feeding point and is disposed on the dielectric substrate. The feeding radiation element extends across the slot of the first metal mechanism element. The ground element is coupled to the main portion of the first metal mechanism element. An antenna structure is formed by the slot of the first metal mechanism element, the dielectric substrate, the feeding radiation element, and the ground element. The second metal mechanism element is disposed opposite from the main portion of the first metal mechanism element. The nonconductive antenna window is connected between the sidewall portion of the first metal mechanism element and the second metal mechanism element.

In some embodiments, the mobile device is a notebook computer. The first metal mechanism element is a keyboard frame. The second metal mechanism element is a base housing.

In some embodiments, the slot of the first metal mechanism element is a closed slot with a straight-line shape.

In some embodiments, the nonconductive antenna window has a cutting retracting design. The nonconductive antenna window is not parallel to the main portion of the first metal mechanism element.

In some embodiments, the mobile device further includes a nonconductive support element filling the slot of the first metal mechanism element. The nonconductive support element is configured to carry the dielectric substrate.

In some embodiments, the mobile device further includes a speaker body. The distance between the speaker body and the feeding radiation element is longer than or equal to 3 mm.

In some embodiments, the mobile device further includes a first conductive gasket, a second conductive gasket, and a conductive cloth. The first conductive gasket is coupled to the main portion of the first metal mechanism element. The second conductive gasket is coupled to the second metal mechanism element. The conductive cloth is coupled between the first conductive gasket and the second conductive gasket. The conductive cloth is adjacent to the speaker body.

In some embodiments, the second metal mechanism element further has a plurality of sound holes adjacent to the speaker body. The distance between the sound holes and the nonconductive antenna window is longer than or equal to 5 mm.

In some embodiments, the antenna structure covers a first frequency band, a second frequency band, a third frequency band, and a fourth frequency band. The first frequency band is from 2400 MHz to 2500 MHz. The second frequency band is from 5150 MHz to 5850 MHz. The third frequency band is from 5900 MHz to 6500 MHz. The fourth frequency band is from 6500 MHz to 7125 MHz.

In some embodiments, the length of the slot of the first metal mechanism element is substantially equal to 0.5 wavelength of the first frequency band. The length of the feeding radiation element is substantially equal to 0.25 wavelength of the fourth frequency band.

### BRIEF DESCRIPTION OF DRAWINGS

The invention can be more fully understood by reading the subsequent detailed description and examples with references made to the accompanying drawings, wherein:

FIG. 1 is a sectional view of a mobile device according to an embodiment of the invention;

FIG. 2 is a partial view of a mobile device according to an embodiment of the invention;

FIG. 3 is another partial view of a mobile device according to an embodiment of the invention;

FIG. 4 is a diagram of radiation gain of an antenna structure of a mobile device according to an embodiment of the invention;

FIG. 5 is a sectional view of a mobile device according to an embodiment of the invention;

FIG. 6 is a partial view of a mobile device according to an embodiment of the invention;

FIG. 7 is another partial view of a mobile device according to an embodiment of the invention; and

FIG. 8 is a perspective view of a notebook computer according to an embodiment of the invention.

### DETAILED DESCRIPTION OF THE INVENTION

In order to illustrate the purposes, features and advantages of the invention, the embodiments and figures of the invention are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

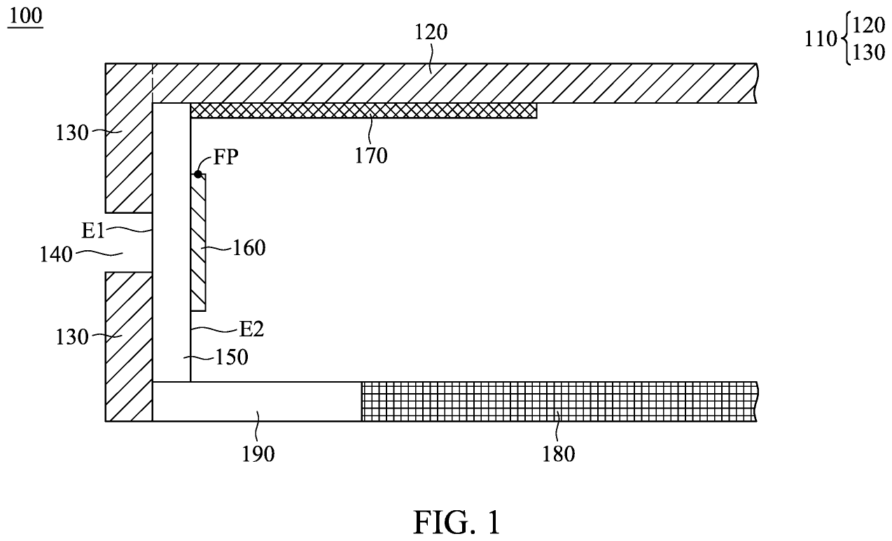

FIG. 1 is a sectional view of a mobile device 100 according to an embodiment of the invention. For example, the mobile device 100 may be a smartphone, a tablet computer, or a notebook computer. As shown in FIG. 1, the mobile device 100 at least includes a first metal mechanism element 110, a dielectric substrate 150, a feeding radiation element 160, a ground element 170, a second metal mechanism element 180, and a nonconductive antenna window 190. The feeding radiation element 160 and the ground element 170 may all both made of metal materials, such as copper, silver, aluminum, iron, or their alloys. It should be understood that the mobile device 100 may further include other components, such as a processor, a touch control panel, a speaker, a power supply module, and/or a housing, although they are not displayed in FIG. 1.

The first metal mechanism element 110 includes a main portion 120 and a sidewall portion 130. The main portion 120 and the sidewall portion 130 may be substantially perpendicular to each other. The sidewall portion 130 of the first metal mechanism element 120 may have a slot 140. It should be noted that the first metal mechanism element 110 and the second metal mechanism element 180 may be appearance elements of the mobile device 100, that is, the elements which eyes of a user can directly observe.

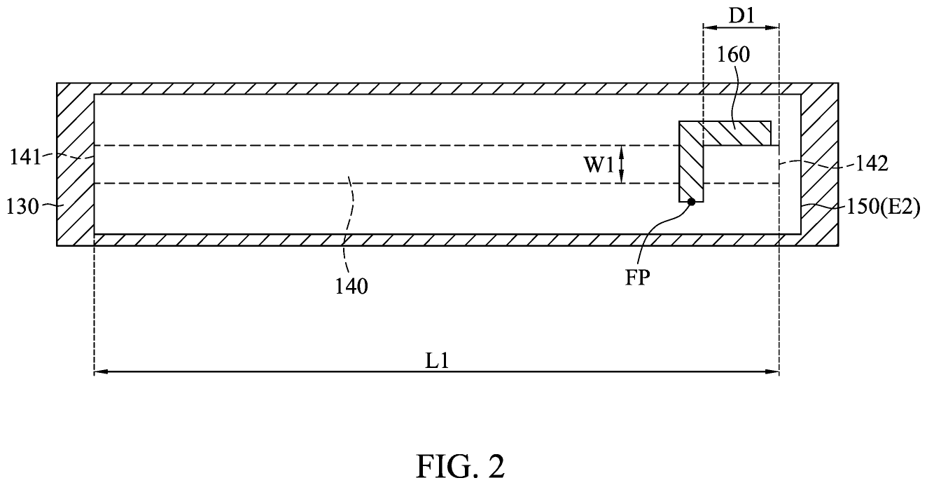

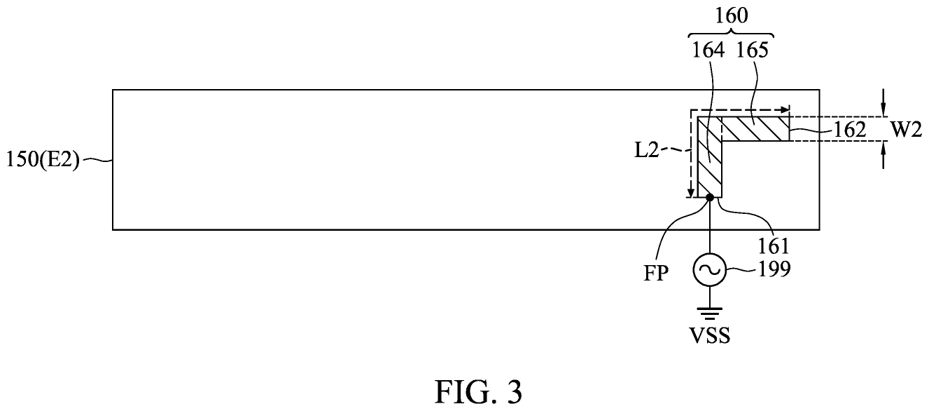

FIG. 2 is a partial view of the mobile device 100 according to an embodiment of the invention. FIG. 3 is another partial view of the mobile device 100 according to an embodiment of the invention. Please refer to FIG. 1, FIG. 2, and FIG. 3 together. The slot 140 of the first metal mechanism element 110 may be a closed slot with a first closed end 141 and a second closed end 142 away from each other. In addition, the slot 140 of the first metal mechanism element 110 may substantially have a straight-line shape.

For example, the dielectric substrate 150 may be an FR4 (Flame Retardant 4) substrate, a PCB (Printed Circuit Board), or a FPC (Flexible Printed Circuit). The dielectric substrate 150 has a first surface E1 and a second surface E2 which are opposite from each other. The first surface E1 of the dielectric substrate 150 is adjacent to the sidewall portion 130 of the first metal mechanism element 110. The feeding radiation element 160 is disposed on the second surface E2 of the dielectric substrate 150. It should be noted that the term “adjacent” or “close” over the disclosure means that the distance (spacing) between two corresponding elements is smaller than a predetermined distance (e.g., 10 mm or the shorter), or means that the two corresponding elements directly touch each other (i.e., the aforementioned distance/spacing between them is reduced to 0). In some embodiments, the first surface E1 of the dielectric substrate 150 is directly attached to the sidewall portion 130 of the first metal mechanism element 110, such that the dielectric substrate 150 can at least partially cover the slot 140 of the first metal mechanism element 110.

The feeding radiation element 160 may substantially have an L-shape. Specifically, the feeding radiation element 160 has a first end 161 and a second end 162. A feeding point FP is positioned at the first end 161 of the feeding radiation element 160. The feeding point FP may be further coupled to a signal source 199. For example, the signal source 199 may be an RF (Radio Frequency) module. In some embodiments, the feeding radiation element 160 includes a first portion 164 adjacent to the first end 161 and a second portion 165 adjacent to the second end 162. The first portion 164 of the feeding radiation element 160 can extend across the slot 140 of the first metal mechanism element 110. The second portion 165 of the feeding radiation element 160 can be substantially parallel to the slot 140 of the first metal mechanism element 110.

The ground element 170 is coupled to the main portion 120 of the first metal mechanism element 110. For example, the ground element 170 may be implemented with a ground copper foil. In a preferred embodiment, an antenna structure of the mobile device 100 is formed by the slot 140 of the first metal mechanism element 110, the dielectric substrate 150, the feeding radiation element 160, and the ground element 170.

The second metal mechanism element 180 is disposed opposite from the main portion 120 of the first metal mechanism element 110. In some embodiments, if the mobile device 100 is a notebook computer, the first metal mechanism element 110 may be a keyboard frame, and the second metal mechanism element 180 may be a base housing. It should be understood that the aforementioned keyboard frame and base housing are equivalent to the so-called “C-component” and “D-component” in the field of notebook computers.

The nonconductive antenna window 190 may be made of a plastic material. The nonconductive antenna window 190 is connected between the sidewall portion 130 of the first metal mechanism element 110 and the second metal mechanism element 180. In some embodiments, the second metal mechanism element 180 further has a notch, and the nonconductive antenna window 190 is embedded in the notch, but it is not limited thereto. The antenna structure of the mobile device 100 can transmit or receive a wireless signal through the nonconductive antenna window 190. In some embodiments, the whole vertical projection of the feeding radiation element 160 is inside the nonconductive antenna window 190.

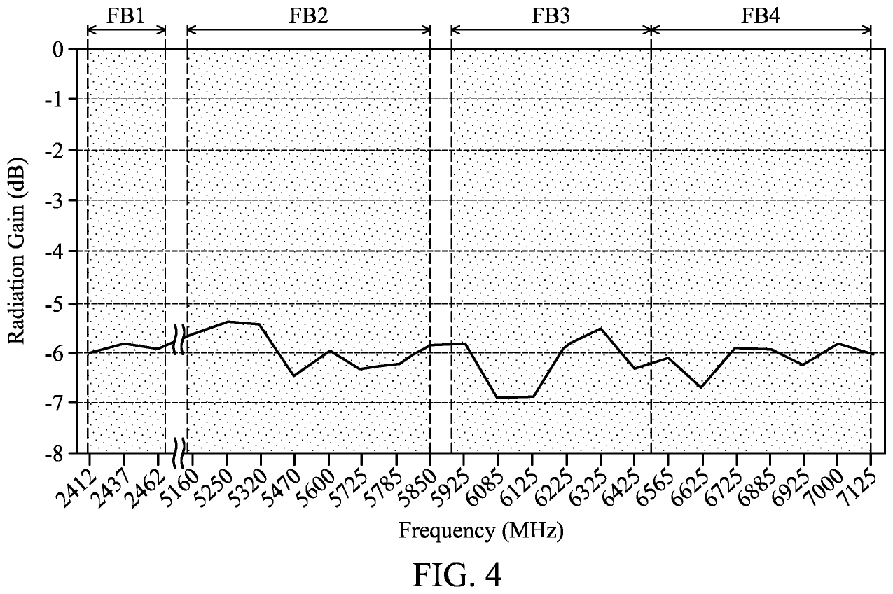

FIG. 4 is a diagram of radiation gain of the antenna structure of the mobile device 100 according to an embodiment of the invention. The horizontal axis represents the operational frequency (MHz), and the vertical axis represents the radiation gain (dB). According to the measurement of FIG. 4, the antenna structure of the mobile device 100 can cover a first frequency band FB1, a second frequency band FB2, a third frequency band FB3, and a fourth frequency band FB4. For example, the first frequency band FB1 may be from 2400 MHz to 2500 MHz, the second frequency band FB2 may be from 5150 MHz to 5850 MHz, the third frequency band FB3 may be from 5900 MHz to 6500 MHz, and the fourth frequency band FB4 may be from 6500 MHz to 7125 MHz. Therefore, the mobile device 100 can support at least the wideband operations of the conventional WLAN (Wireless Local Area Network) and the next-generation Wi-Fi 6E.

In some embodiments, the operational principles of the antenna structure of the mobile device 100 will be described as follows. The slot 140 of the first metal mechanism element 110 is excited to generate a fundamental resonant mode, thereby forming the aforementioned first frequency band FB1. The slot 140 of the first metal mechanism element 110 is further excited to generate a first higher resonant mode, thereby forming the aforementioned second frequency band FB2. The slot 140 of the first metal mechanism element 110 is further excited to generate a second higher resonant mode, thereby forming the aforementioned third frequency band FB3. The slot 140 of the first metal mechanism element 110 is further excited to generate a third higher resonant mode, thereby forming the aforementioned fourth frequency band FB4. In addition, the feeding radiation element 160 is configured to fine-tune the impedance matching of the aforementioned fourth frequency band FB4, thereby increasing the operational bandwidth thereof.

In some embodiments, the element sizes of the mobile device 100 will be described as follows. The length L1 of the slot 140 of the first metal mechanism element 110 may be substantially equal to 0.5 wavelength (λ/2) of the first frequency band FB1 of the antenna structure of the mobile device 100. The width W1 of the slot 140 of the first metal mechanism element 110 may be may be from 1 mm to 3 mm. The length L2 of the feeding radiation element 160 may be substantially equal to 0.25 wavelength (λ/4) of the fourth frequency band FB4 of the antenna structure of the mobile device 100. The width W2 of the feeding radiation element 160 may be from 0.5 mm to 2 mm. The distance D1 between the first portion 164 of the feeding radiation element 160 and the second closed end 142 of the slot 140 may be shorter than or equal to 0.25 wavelength (λ/4) of the fourth frequency band FB4 of the antenna structure of the mobile device 100. The above ranges of element sizes are calculated and obtained according to many experiment results, and they help to optimize the operational bandwidth and impedance matching of the antenna structure of the mobile device 100.

The following embodiments will introduce different configurations and detail structural features of the mobile device 100. It should be understood that these figures and descriptions are merely exemplary, rather than limitations of the invention.

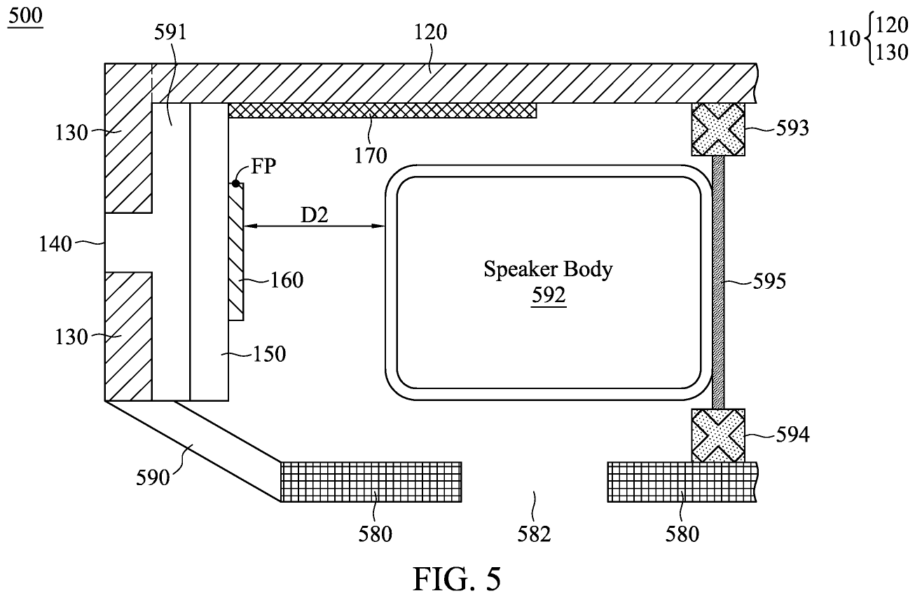

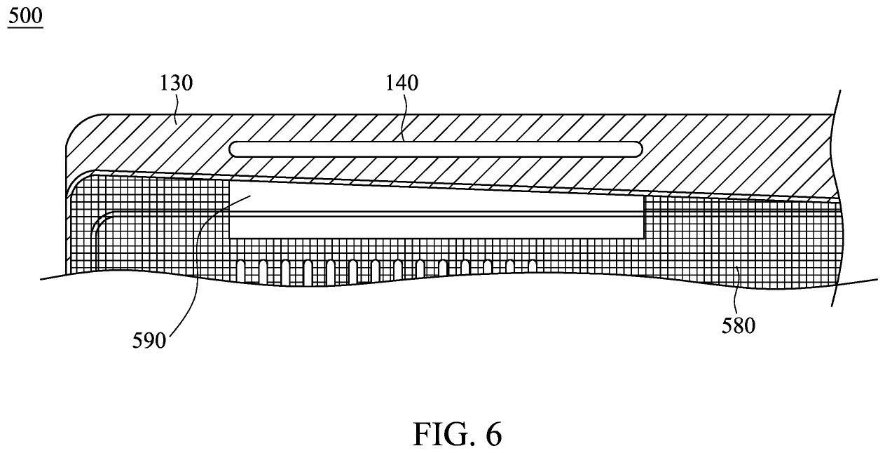

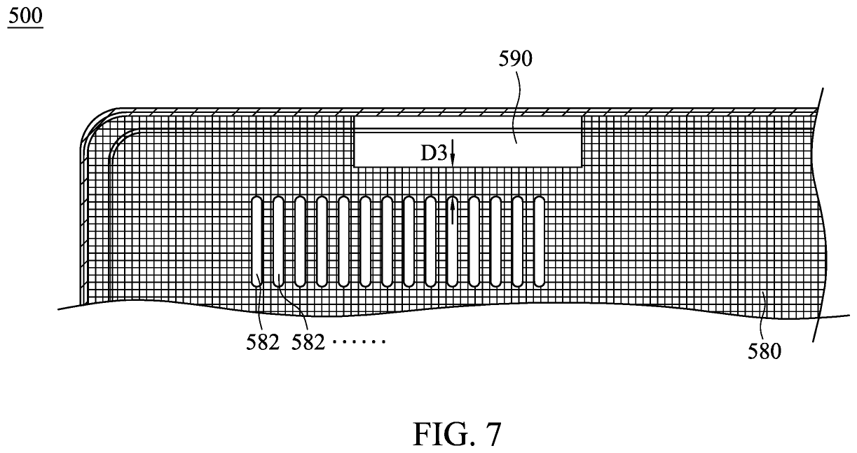

FIG. 5 is a sectional view of a mobile device 500 according to an embodiment of the invention. FIG. 6 is a partial view of the mobile device 500 according to an embodiment of the invention. FIG. 7 is another partial view of the mobile device 500 according to an embodiment of the invention. Please refer to FIG. 5, FIG. 6, and FIG. 7 together. FIG. 5, FIG. 6, and FIG. 7 are similar to FIG. 1, FIG. 2, and FIG. 3. In the embodiment of FIG. 5, FIG. 6, and FIG. 7, a second metal mechanism element 580 of the mobile device 500 has a plurality of sound holes 582. A nonconductive antenna window 590 of the mobile device 500 has a cutting retracting design, and it is not parallel to the main portion 120 of the first metal mechanism element 110. In addition, the mobile device 500 further includes a nonconductive support element 591, a speaker body 592, a first conductive gasket 593, a second conductive gasket 594, and a conductive cloth 595.

The nonconductive support element 591 is made of a plastic material, and it is disposed between the sidewall portion 130 of the first metal mechanism element 110 and the dielectric substrate 150. The nonconductive support element 591 can fill the slot 140 of the first metal mechanism element 110. In addition, the nonconductive support element 591 is also configured to carry the dielectric substrate 150. It should be noted that the incorporation of the nonconductive support element 591 can help to reduce the difficulty of manufacturing an antenna structure for the mobile device 500.

The speaker body 592 is made of a metal material, and it may be covered by a plastic housing. In some embodiments, the distance D2 between the speaker body 592 and the feeding radiation element 160 is longer than or equal to 3 mm. According to practical measurements, the aforementioned range of the distance D2 can prevent the speaker body 592 from negatively affecting the radiation performance of the antenna structure of the mobile device 500. Furthermore, the speaker body 592 is adjacent to the sound holes 582 of the second metal mechanism element 580. In some embodiments, the distance D3 between the sound holes 582 of the second metal mechanism element 580 and the nonconductive antenna window 590 is longer than or equal to 5 mm, so as to enhance the structural robustness of the second metal mechanism element 580.

The first conductive gasket 593 is coupled to the main portion 120 of the first metal mechanism element 120. The second conductive gasket 594 is coupled to the second metal mechanism element 580. The conductive cloth 595 is coupled between the first conductive gasket 593 and the second conductive gasket 594. The conductive cloth 595 is adjacent to the speaker body 592, or it is directly attached to the speaker body 592. According to practical measurements, the incorporation of the conductive cloth 595 can help to reduce the EMI (Electromagnetic Interference) from the antenna structure of the mobile device 500. In addition, since the antenna structure of the mobile device 500 is integrated with the speaker body 592, the overall size of the mobile device 500 can be reduced further. Other features of the mobile device 500 of FIG. 5, FIG. 6, and FIG. 7 are similar to those of the mobile device 100 of FIG. 1, FIG. 2, and FIG. 3. Accordingly, the two embodiments can achieve similar levels of performance.

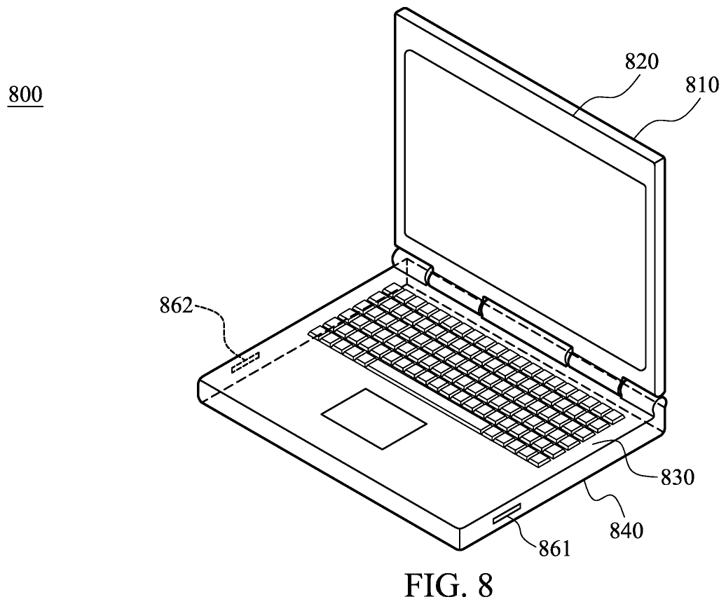

FIG. 8 is a perspective view of a notebook computer 800 according to an embodiment of the invention. In the embodiment of FIG. 8, the aforementioned antenna structure is applied in the notebook computer 800. The notebook computer 800 includes an upper housing 810, a display frame 820, a keyboard frame 830, and a base housing 840. It should be understood that the upper housing 810, the display frame 820, the keyboard frame 830, and the base housing 840 are respectively equivalent to the so-called “A-component”, “B-component”, “C-component”, and “D-component” in the field of notebook computers. For example, the aforementioned antenna structure may be disposed at a first position 861 or a second position 862 of the notebook computer 800. According to practical measurements, if the aforementioned antenna structure is disposed at the first position 861 or the second position 862, the notebook computer 800 will tend to meet the general requirements of SAR (Specific Absorption Rate).

The invention proposes a novel mobile device with a novel antenna structure. In comparison to the conventional design, the invention has several advantages, including its small size, wide bandwidth, low manufacturing cost, and improved SAR. Therefore, the invention is suitable for application in a variety of communication devices.

Note that the above element sizes, element shapes, and frequency ranges are not limitations of the invention. An antenna designer can fine-tune these settings or values according to different requirements. It should be understood that the mobile device of the invention is not limited to the configurations of FIGS. 1-8. The invention may merely include any one or more features of any one or more embodiments of FIGS. 1-8. In other words, not all of the features displayed in the figures should be implemented in the mobile device of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile device supporting wideband operations, comprising:
a first metal mechanism element, comprising a main portion and a sidewall portion, wherein the sidewall portion has a slot;
a dielectric substrate, disposed adjacent to the sidewall portion of the first metal mechanism element;
a feeding radiation element, having a feeding point, and disposed on the dielectric substrate, wherein the feeding radiation element extends across the slot of the first metal mechanism element;
a ground element, coupled to the main portion of the first metal mechanism element, wherein an antenna structure is formed by the slot of the first metal mechanism element, the dielectric substrate, the feeding radiation element, and the ground element;
a second metal mechanism element, disposed opposite from the main portion of the first metal mechanism element; and
a nonconductive antenna window, connected between the sidewall portion of the first metal mechanism element and the second metal mechanism element.

2. The mobile device as claimed in claim 1, wherein the mobile device is a notebook computer.

3. The mobile device as claimed in claim 1, wherein the first metal mechanism element is a keyboard frame, and the second metal mechanism element is a base housing.

4. The mobile device as claimed in claim 1, wherein the slot of the first metal mechanism element is a closed slot with a straight-line shape.

5. The mobile device as claimed in claim 1, wherein the nonconductive antenna window has a cutting retracting design.

6. The mobile device as claimed in claim 1, wherein the nonconductive antenna window is not parallel to the main portion of the first metal mechanism element.

7. The mobile device as claimed in claim 1, further comprising:
a nonconductive support element, filling the slot of the first metal mechanism element, wherein the nonconductive support element is configured to carry the dielectric substrate.

8. The mobile device as claimed in claim 1, further comprising:
a speaker body, wherein a distance between the speaker body and the feeding radiation element is longer than or equal to 3 mm.

9. The mobile device as claimed in claim 8, further comprising:
a first conductive gasket, coupled to the main portion of the first metal mechanism element;
a second conductive gasket, coupled to the second metal mechanism element; and
a conductive cloth, coupled between the first conductive gasket and the second conductive gasket, wherein the conductive cloth is adjacent to the speaker body.

10. The mobile device as claimed in claim 8, wherein the second metal mechanism element further has a plurality of sound holes adjacent to the speaker body.

11. The mobile device as claimed in claim 10, wherein a distance between the sound holes and the nonconductive antenna window is longer than or equal to 5 mm.

12. The mobile device as claimed in claim 1, wherein the antenna structure covers a first frequency band, a second frequency band, a third frequency band, and a fourth frequency band.

13. The mobile device as claimed in claim 12, wherein the first frequency band is from 2400 MHz to 2500 MHz, the second frequency band is from 5150 MHz to 5850 MHz, the third frequency band is from 5900 MHz to 6500 MHz, and the fourth frequency band is from 6500 MHz to 7125 MHz.

14. The mobile device as claimed in claim 12, wherein a length of the slot of the first metal mechanism element is substantially equal to 0.5 wavelength of the first frequency band.

15. The mobile device as claimed in claim 12, wherein a length of the feeding radiation element is substantially equal to 0.25 wavelength of the fourth frequency band.
